(19) United States
(12) Patent Application Publication
(10) Pub. No.: US 2012/0169719 A1
(43) Pub. Date: Jul. 5, 2012

(54) METHOD FOR COMPENSATING DATA, COMPENSATING APPARATUS FOR PERFORMING THE METHOD AND DISPLAY APPARATUS HAVING THE COMPENSATING APPARATUS

(75) Inventors: Yun-Jae KIM, Asan-si (KR); Byoung-Jun LEE, Cheonan-si (KR); Bo-Ram KIM, Asan-si (KR); Seung-Hwan MOON, Asan-si (KR); Nam-Hee GOO, Asan-si (KR); Myoung-Chul KIM, Dongducheon-si (KR); Jae-Ho CHOI, Seongnam-si (KR)

(73) Assignee: SAMSUNG ELECTRONICS CO., LTD., Suwon-si (KR)

(21) Appl. No.: 13/182,039

(22) Filed: Jul. 13, 2011

(30) Foreign Application Priority Data
Dec. 31, 2010 (KR) 2010-0139827

(51) Int. Cl. G06T 15/00

(52) U.S. Cl. 345/419

(57) ABSTRACT

A method of compensating data includes: generating color correction data of primary image data using a plurality of three-dimensional look-up tables in response to the primary image data and a stereoscopic image mode signal, where stored color correction data in the three-dimensional look-up tables are mapped with reference data in the three-dimensional look-up tables in one-to-three correspondence, and a gradation range of the stored color correction data in the three-dimensional look-up tables is less than a gradation range of the primary image data; and converting the generated color correction data to compensated data based on the generated color correction data of the primary image data and the color correction data of the primary image data of a previous frame, wherein a gradation range of the compensated data is substantially identical to the gradation range of the primary image data.

This application claims priority to Korean Patent Application No. 2010-139827, filed on Dec. 31, 2010, and all the benefits accruing therefrom under 35 U.S.C.§119, the content of which in its entirety is herein incorporated by reference.

### BACKGROUND OF THE INVENTION

(1) Field of the Invention

Exemplary embodiments of the present invention relate to a method for compensating data, a compensating apparatus for performing the method and a display apparatus having the compensating apparatus. More particularly, exemplary embodiments of the present invention relate to a method for compensating data employed to a liquid crystal display apparatus, a compensating apparatus for performing the method and a display apparatus including the compensating apparatus.

(2) Description of the Related Art

Generally, a liquid crystal display (“LCD”) apparatus includes an LCD panel displaying an image using a light transmittance of a liquid crystal and a backlight assembly disposed below the LCD panel to provide the LCD panel with lights.

Generally, the LCD apparatus uses a same electric signal assuming that electrical and optical characteristics of red R, green G and blue B are substantially identical to each other, even though the electrical and optical characteristics of red R, green G and blue B are substantially different from each other. Thus, gamma curves corresponding to red R, green G and blue B do not correspond to a same curve, such that a color sense is not uniform or deviated into one side.

Therefore, an adaptive color correction (“ACC”) technology, which dependently transforms red R, green G and blue B grammar curves to improve image quality, has been employed in the LCD apparatus. In the ACC technology, a memory such as a random-access memory (“RAM”) and a read only memory (“ROM”), for example, in which input data and compensation data are one-to-one mapped in a look-up table (“LUT”) type may be used. More particularly, when an input data is received from an external device, a compensation data corresponding to the input data stored in the LUT is outputted.

When displaying a stereoscopic image, a crosstalk may be generated due to a response speed of a liquid crystal, a scanning time of a backlight assembly and an on/off time of a left-eye glass and a right-eye glass, for example.

As technology of moving image is developed, response speed of liquid crystal becomes a major valuation standard in a market. In order to optimize the response speed of a liquid crystal of the LCD device, a controller of the display device may operate in an overdrive mode in which over-compensated or under-compensated (higher or lower) drive current is provided to speed up the time to reach a desired brightness. In order to perform the overdrive mode, a dynamic capacitance compensation (“DCC”) may be used. When the DCC is used, an overdriving value of a gradation data may be determined based on comparison between the gradation data corresponding to the preceding frame and a gradation data corresponding to a current frame.

When using an overdrive circuit, an LUT that stores measured overdrive values is typically used since the overdrive value determined based on the comparison between current and previous gradation data does not changed linearly with gray level owing to liquid crystal properties.

However, when a stereoscopic image is displayed, a time, which is required to reach a maximum gradation value from a minimum gradation value within a unit frame, may not be ensured, such that a crosstalk may be generated.

### BRIEF SUMMARY OF THE INVENTION

Exemplary embodiments of the present invention provide a method of compensating data with reduced crosstalk of a stereoscopic image.

Exemplary embodiments of the present invention also provide a data compensation apparatus for performing the above-mentioned method.

Exemplary embodiments of the present invention further also provide a display apparatus having the above-mentioned data compensation apparatus.

According to an exemplary embodiment, a method of compensating data is provided. The method includes generating color correction data of primary image data using a plurality of three-dimensional look-up tables in response to the primary image data and a stereoscopic image mode signal, where stored color correction data in the three-dimensional look-up tables are mapped with reference data in the three-dimensional look-up tables in one-to-three correspondence, and a gradation range of the stored color correction data in the three-dimensional look-up tables is less than a gradation range of the primary image data; and converting the generated color correction data to compensated data based on the generated color correction data of the primary image data and the color correction data of the primary image data of a previous frame, wherein a gradation range of the compensated data is substantially identical to the gradation range of the primary image data.

In an exemplary embodiment, a minimum gradation value of the stored color correction data in the three-dimensional look-up tables may be substantially equal to a minimum gradation value of the primary image data, a maximum gradation value of the stored color correction data in the three-dimensional look-up tables may be less than a maximum gradation value of the primary image data, and the maximum gradation value of the stored color correction data in the three-dimensional look-up tables may correspond to a maximum gradation value of the compensated data perceived in a unit frame.

In an exemplary embodiment, the generating color correction data of primary image data may include: outputting the stored color correction data in the three-dimensional look-up tables from the three-dimensional look-up tables; and interpolating the outputted stored color correction data in the three-dimensional look-up tables to compute the color correction data of the primary data.

In an exemplary embodiment, the generating color correction data of primary image data may include: determining whether or not red data of the primary image data, green data of the primary image data and blue data of the primary image data are substantially identical to each other; outputting the color correction data of the primary image data using a plurality of one-dimensional look-up tables when the red, green and blue data of the primary image data are substantially identical to each other; and outputting the color correction data of the primary image data using the one-dimensional look-up tables and the three-dimensional look-up tables when the red, green and blue data of the primary image data are different from each other.

In an exemplary embodiment, the generating color correction data of a primary image data may include temporally or spatially dithering the color correction data of the primary image data.

According to an alternative exemplary embodiment, a data compensation apparatus includes: a three-dimensional color correcting part configured to generate color correction data of primary image data using a plurality of three-dimensional look-up tables in response to the primary image data and a stereoscopic image mode signal, where stored color correction data in the three-dimensional look-up tables are mapped with reference data in the three-dimensional look-up tables in one-to-three correspondence, and a gradation range of the stored color correction data in the three-dimensional look-up tables is less than a gradation range of the primary image data; and an over-driving part configured to convert the generated color correction data to a compensated data based on the generated color correction data of the primary image data and the color correction data of the primary image data of a previous frame, where a gradation range of the compensated data is substantially identical to a gradation range of the primary image data.

In an exemplary embodiment, a minimum gradation value of the stored color correction data in the three-dimensional look-up tables may be substantially equal to a minimum gradation value of the primary image data, a maximum gradation value of the stored color correction data in the three-dimensional look-up tables may be less than a maximum gradation value of the primary image data, and the maximum gradation value of the stored color correction data in the three-dimensional look-up tables may correspond to a maximum gradation value of the compensated data perceived in a unit frame.

In an exemplary embodiment, the three-dimensional color correcting part may include a three-dimensional interpolating part configured to interpolate the stored color correction data in the three-dimensional look-up tables to compute the color correction data of the primary image data.

In an exemplary embodiment, a total gradation number of the primary image data may be L, which is a natural number, and the number of the reference data in each of the three-dimensional look-up tables may be M, which is a natural number less than L.

In an exemplary embodiment, the reference data in each of the three-dimensional look-up tables may be stored in N-gradation interval, where N is a divisor of.

In an exemplary embodiment, the reference data in each of the three-dimensional look-up tables may be stored in P-gradation interval on a middle gradation area, and may be stored in Q-gradation interval on each of a low gradation area and a high gradation area, where P is a natural number, and Q is a natural number less than P.

In an exemplary embodiment, the reference data in each of the three-dimensional look-up tables may be stored in P-gradation interval on a middle gradation area, may be stored in Q-gradation interval on a low gradation area, and may be stored in R-gradation interval on a high gradation area, where P is a natural number, Q is a natural number less than P, and R is a natural number less than P and different from Q.

In an exemplary embodiment, each of the three-dimensional look-up tables may include: a red look-up table, in which red color correction data in correspondence with red, green and blue data of the primary image data are mapped; a green look-up table, in which green color correction data in correspondence with the red, green and blue data of the primary image data are mapped; and a blue look-up table, in which blue color correction data in correspondence with the red, green and blue data of the primary image data are mapped.

In an exemplary embodiment, the data compensation apparatus may further include a one-dimensional color correcting part, where the one-dimensional color correcting part includes: a one-dimensional look-up table, in which stored color correction data therein are mapped with reference data therein in one-to-one correspondence; and a one-dimensional color interpolating part configured to interpolate the stored color correction data in the one-dimensional look-up tables to compute the color correction data of the primary image data.

In an exemplary embodiment, the three-dimensional color correcting part may output the color correction data of the primary image data to the one-dimensional color correcting part.

In an exemplary embodiment, the data compensation apparatus may further include an achromatic color determining part configured to determine whether or not red data of the primary image data, green data of the primary image data and blue data of the primary image data are substantially identical to each other, to output the primary image data to the one-dimensional color correcting part when the red, green and blue data of the primary image data are substantially identical to each other, and to output the primary image data to the three-dimensional color correcting part when the red, green and blue data of the primary image data are different from each other.

In an exemplary embodiment, the data compensation apparatus may further include a dithering part configured to temporally or spatially dither the color correction data of the primary image data.

According to another alternative exemplary embodiment of the present invention, a display apparatus includes a stereoscopic image determining part configured to determine whether or not primary image data provided from an external device are stereoscopic image data to output the primary image data when the primary image data are the stereoscopic image data; a data compensating part; a display panel which displays an image; a panel driving part configured to provide the display panel with the compensated data; a light source part disposed below the display panel and configured to provide the display panel with lights; and a light source driver configured to drive the light source part. The data compensating part includes a three-dimensional color correcting part configured to generate color correction data of primary image data using a plurality of three-dimensional look-up tables in response to the primary image data and a stereoscopic image mode signal, where stored color correction in the three-dimensional look-up tables data is mapped with reference data in the three-dimensional look-up tables, and a gradation range of the stored color correction data in the three-dimensional look-up tables is less than a gradation range of the primary image data; and an over-driving part configured to convert the generated color correction data of the primary image data to a compensated data based on the generated color correction data of the primary image data and the color correction data of the primary image data of a previous frame, where a gradation range of the compensated data is substantially identical to a gradation range of the primary image data.

In an exemplary embodiment, the light source driver may increase a luminance of the light source part in response to the stereoscopic image mode signal.

In an exemplary embodiment, the stereoscopic image determining part may output the stereoscopic image mode signal based on at least one of a toggle signal provided from the external device and a stereoscopic image enable signal provided from the external device.

According to exemplary embodiments of the present invention, the color correction data of the primary image data are generated such that a maximum gradation value of the color correction data of the primary image data corresponds to a maximum gradation value of the compensated data perceived in a unit frame interval, and crosstalk generated due to response delay of liquid crystals is thereby substantially reduced, and display quality of a display apparatus is thereby substantially improved.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a block diagram showing an exemplary embodiment of a display apparatus according to the present invention;

FIG. 2 is a block diagram showing an exemplary embodiment of a data compensating part of FIG. 1;

FIG. 3 is a conceptual diagram showing an exemplary of a three-dimensional (“3D”) look-up table of FIG. 2;

FIGS. 4 to 7 are conceptual diagrams showing gamma curves of color correction data and reference data in the 3D look-up table of FIG. 2;

FIG. 8 is a conceptual diagram showing an exemplary embodiment of an interpolation method used in a 3D interpolating part of FIG. 2;

FIG. 9 is a block diagram showing an alternative exemplary embodiment of the data compensating part according to the present invention;

FIG. 10 is a block diagram showing another alternative exemplary embodiment of the data compensating part according to the present invention; and

FIG. 11 is a block diagram showing an alternative exemplary embodiment of the data compensating part according to the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “applied to” another element or layer, the element or layer can be directly on, connected or applied to another element or layer or intervening elements or layers. In contrast, when an element is referred to as being “directly on,” “directly connected to” or “directly applied to” another element or layer, there are no intervening elements or layers present. As used herein, “connected” includes physically and/or electrically connected. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

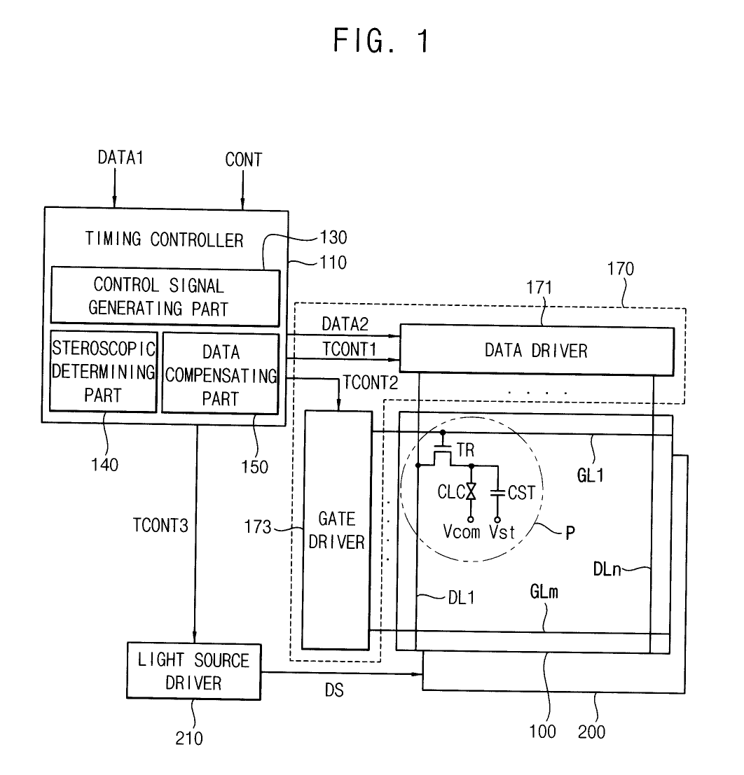

FIG. 1 is a block diagram of an exemplary embodiment of a display apparatus according to the present invention.

Referring to FIG. 1, a display apparatus includes a display panel 100, a timing controller 110, a panel driving part 170, a light source part 200 and a light source driver 210.

The display panel 100 includes a plurality of gate lines GL1 to GLm, a plurality of data lines DL1 to DLn and a plurality of pixels P. Here, ‘m’ and ‘n’ are natural numbers. Each of the pixels includes a pixel driving element TR, a liquid crystal capacitor CLC electrically connected to the pixel driving element TR and a storage capacitor CST electrically connected to the pixel driving element TR. The display panel 100 may include two opposite substrates and a liquid crystal layer interposed between the two opposite substrates.

The timing controller 110 may include a control signal generating part 130, a stereoscopic determining part 140 and a data compensating part 150. The timing controller 110 receives primary image data DATA1 and a control signal CONT from an external device (not shown). The primary image data DATA1 is digital data corresponding to a gradation of an image. In an exemplary embodiment, the primary image data DATA1 may include a red data, a green data and a blue data, but not being limited thereto.

The control signal generating part 130 generates a first timing control signal TCONT1 to control a driving timing of a data driver 171 and a second timing control signal TCONT2 to control a driving timing of a gate driver 173.

In an exemplary embodiment, the timing control signal TCONT1 may include a horizontal start signal, an inverse signal and an output enable signal, for example, but not being limited thereto. In an exemplary embodiment, the second timing control signal TCONT2 may include a vertical start signal, a gate clock signal and an output enable signal, for example, but not being limited thereto.

The stereoscopic image determining part 140 receives the primary image data DATA1 and the control signal CONT, and determines whether or not the primary image data DATA1 are stereoscopic image data. The control signal CONT may include a toggle signal or a stereoscopic image enable signal. The stereoscopic image determining part 140 may determine whether or not the primary image data DATA1 are stereoscopic image data based on at least one of the toggle signal and the stereoscopic image enable signal.

The stereoscopic image determining part 140 may generate a stereoscopic image mode signal 3D-mode when the primary image data DATA1 are stereoscopic image data, and may generate a planar image mode signal 2D-mode when the primary image data DATA1 are not stereoscopic image data.

The stereoscopic image determining part 140 provides the data compensating part 150 with the stereoscopic image mode signal 3D-mode and the planar image mode signal 2D-mode. In an exemplary embodiment, the stereoscopic image determining part 140 may provide the light source driver 120 with the stereoscopic image mode signal 3D-mode and the planar image mode signal 2D-mode.

The data compensating part 150 outputs compensated data DATA2 corresponding to the primary image data DATA1. When the primary image data DATA1 are stereoscopic image data, the data compensating part 150 generates color correction data DATA having a gradation range less than a gradation range of the primary image data DATA1, and converts the color correction data DATA to the compensated data DATA2 having a gradation range substantially identical to a gradation range of the primary image data DATA1. The color correcting part 300 will be described later in greater detail.

The panel driving part 170 includes a data driver 171 and a gate driver 173. The panel driving part 170 provides the display panel 100 with the compensated data DATA2. The display panel 100 displays an image based on the compensated data DATA2.

The data driver 171 converts the compensated data of a current frame to an analog data voltage. The data driver 171 outputs the data voltage to the data lines DL1 to DLm.

The gate driver 173 outputs a plurality of gate signals to the gate lines GL1 to GLn in synchronized with output timing of the data driver 171.

The light source part 200 is disposed adjacent to, e.g., below, the display panel 100 to provide the display panel 100 with lights. The light source part 200 may further include a light guide plate (not shown). The light source part 200 may be disposed in at least one side surface of the light guide plate.

The light source part 200 may include a point light source, for example, a light-emitting diode (“LED”). The light source part 200 may include a red LED which emits red lights, a green LED which emits green lights and a blue LED which emits blue lights.

The light source driver 210 drives the light source part 200. The light source driver 210 provides the light source part 200 with a light source driving signal DS based on a signal from the timing controller 110. In an exemplary embodiment, the timing controller 110 provides the light source part 200 with a third timing control signal TCONT3 to control the light source driver 210. The third timing control signal TCONT3 may include the stereoscopic image mode signal 3D-mode and the planar image mode signal 2D-mode that are provided from the stereoscopic image determining part 140.

When the stereoscopic image mode signal 3D-mode is provided to the light source driver 210, the light source driver 210 may increase a luminance of the light source part 200 to be higher than a luminance of the light source part 200 when the planar image mode signal 2D-mode is provided thereto. The light source driver 210 may boost the light source driving signal DS to increase a luminance of the light source part 200.

In an exemplary embodiment, a duty width or amplitude of the light source driving signal DS may be increased to boost the light source driving signal DS. In such an embodiment, the light source part 200 may provide a high luminance to the display panel 100 while a stereoscopic image is displayed on the display panel 100.

Thus, a luminance decrease due to the color correction data DATA having a gradation range less than a gradation range of the primary image data DATA1 at the data compensating part 150 may be compensated by a luminance increase of the light source part 200.

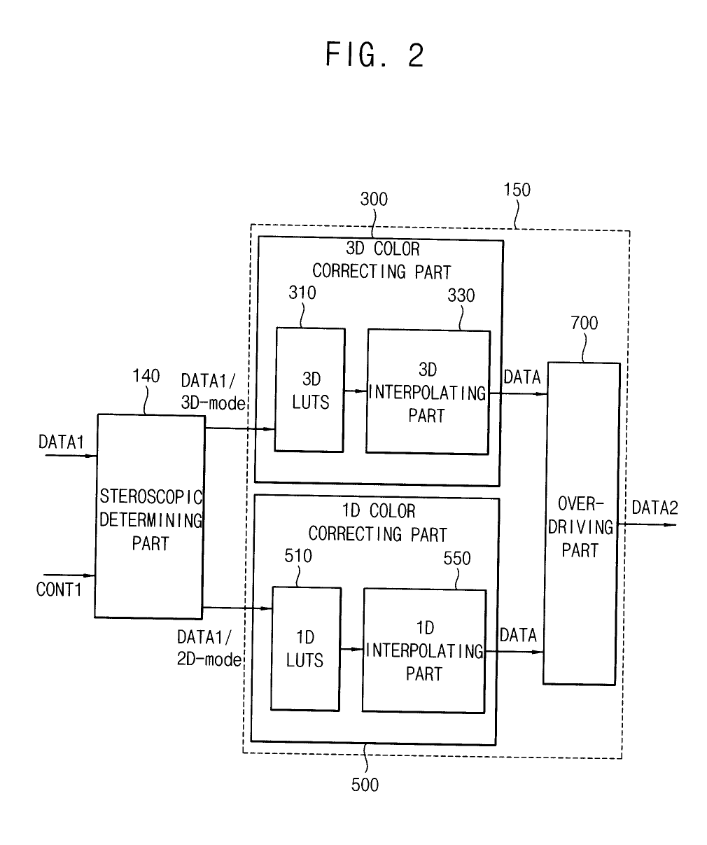

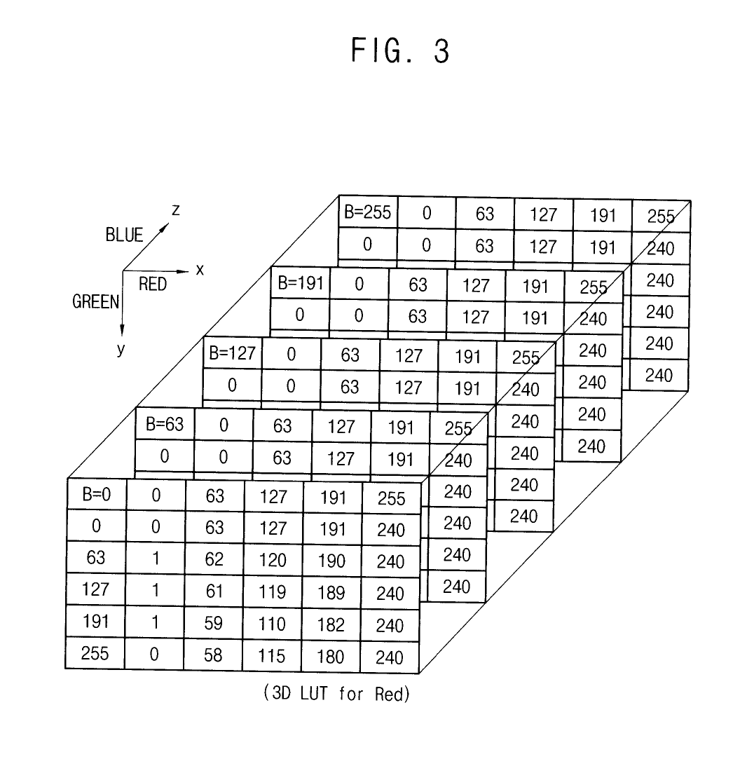

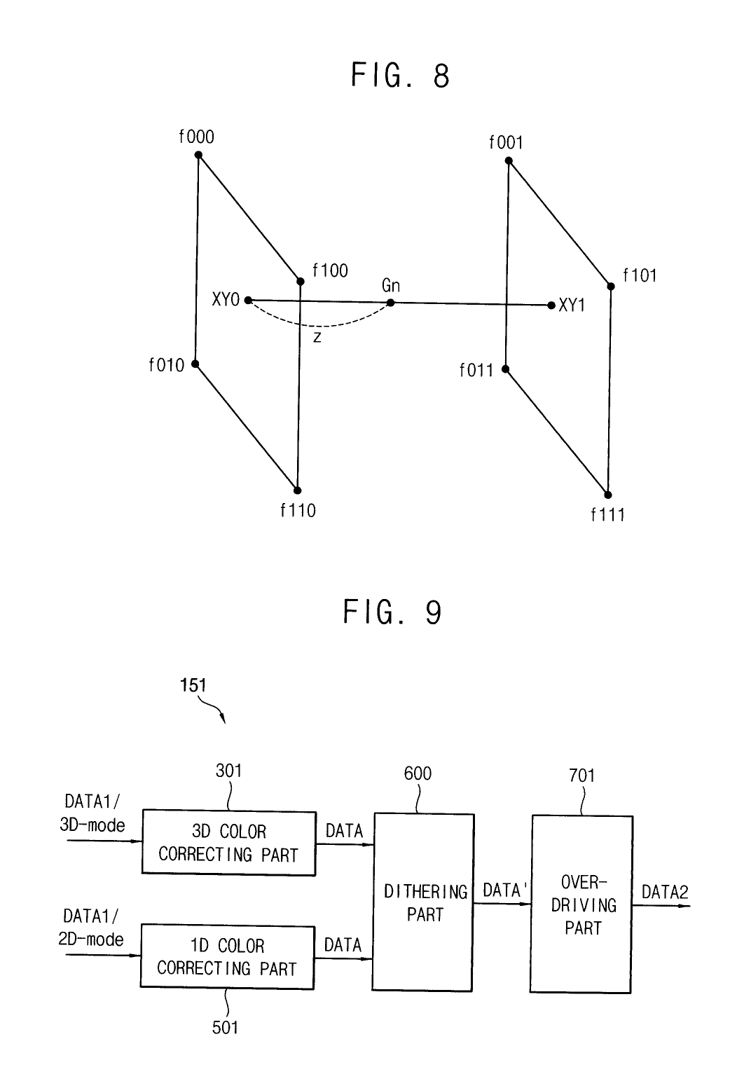

FIG. 2 is a block diagram of an exemplary embodiment of the data compensating part 150 of FIG. 1. FIG. 3 is a diagram explaining an exemplary of a three-dimensional (“3D”) look-up table (“LUT”) in FIG. 2. FIGS. 4 to 7 are conceptual diagrams showing gamma curves of stored color correction data and reference data in the 3D LUT of FIG. 2. FIG. 8 is a conceptual diagram showing an exemplary embodiment of an interpolation method used in a 3D interpolating part of FIG. 2.

Referring to FIGS. 2 to 8, the data compensating part 150 includes a 3D color correcting part 300, a one-dimensional (“1D”) color correcting part 500 and an over-driving part 700. In FIG. 2, for convenience of description, the stereoscopic image determining part 140 is shown together with the data compensating part 150.

The stereoscopic image determining part 140 provides the 3D color correcting part 300 with the stereoscopic image mode signal 3D-mode and the primary image data DATA1, when the primary image data DATA1 is stereoscopic image data. The stereoscopic image determining part 140 provides the 1D color correcting part 500 with the planar image mode signal 2D-mode and the primary image data DATA1, when the primary image data DATA1 is not stereoscopic image data.

The 3D color correcting part 300 generates the color correction data DATA of the primary image data DATA1 in response to the stereoscopic image mode 3D mode. The 3D color correcting part 300 includes a plurality of 3D LUTs 310 and a 3D interpolating part 330.

In the 3D LUTs 310, stored color correction data DATA therein are mapped with reference data therein in one-to-three correspondence. In an exemplary embodiment, the reference data may include red data, green data and blue data, and each of the stored color correction data may correspond to one of the red data, green data and blue data of the reference data.

When all of red, green and blue data of the primary image data DATA1 are identical to the reference data stored in the 3D LUTs 310, the color correction data DATA may be directly outputted from the 3D LUTs 310.

When one or two of the red, green and blue data of the primary image data DATA1 are identical to the reference data stored in the 3D LUTs 310 or all of the red, green and blue data of the primary image data DATA1 are not identical to the reference data stored in the 3D LUTs 310, the 3D interpolating part 330 interpolates the stored color correction data in the 3D LUTs 310 to output the color correction data DATA. The 3D interpolating part 330 will be described later in greater detail.

A gradation range of the stored color correction data in the 3D LUTs 310 is less than the gradation range of the primary image data DATA1. In one exemplary embodiment, for example, a minimum gradation value of the stored color correction data in the 3D LUTs 310 may be substantially equal to a minimum gradation value of the primary image data DATA1, and a maximum gradation value of the stored color correction data in the 3D LUTs 310 may be substantially less than a maximum gradation value of the primary image data DATA1. The maximum gradation value of the stored color correction data in the 3D LUTs 310 may be corresponding to a maximum gradation value of the compensated data DATA2 perceived in a unit frame interval.

The 3D LUTs 310 may include the stored color correction data for red, the stored color correction data for green, and the stored color correction data for blue. In one exemplary embodiment, for example, the 3D LUTs 310 may include a red LUT, in which the stored color correction data for red are mapped in correspondence with the red, green and blue data, a green LUT, in which the stored color correction data for green are mapped in correspondence with the red, green and blue data, and a blue LUT, in which the stored color correction data for blue are mapped in correspondence with the red, green and blue data.

A maximum gradation value of the stored color correction data in the 3D LUTs 310 is less than a maximum gradation value of the primary image data DATA1. A difference between the maximum gradation of the stored color correction data and the maximum gradation value of the primary image data DATA1 may correspond to a compensation value of a maximum gradation value of the compensated data DATA2. In one exemplary embodiment, for example, when the primary image data DATA1 are 8 bits data, that is, a data having a gradation range of 0-gradation to 255-gradation, the stored color correction data may have a gradation range of 0-gradation to 240-gradation.

In such an embodiment, the stored color correction data in the 3D LUTs 310 may be set based on an experiment value within a range of 0-gradation to 240-gradation. In an alternative exemplary embodiment, the stored color correction data is the 3D LUTs 310 are set within a gradation range of 0-gradation to 255-gradation, and then gradations greater than 240-gradation may be again set into 240-gradation.

The 3D LUTs 310 may store the stored color correction data corresponding to all data of the primary image data DATA1. In one exemplary embodiment, for example, when the primary image data DATA1 are 8 bits data, each of the 3D LUTs 310 may have a reference data corresponding to the primary image data DATA1, that is a reference data of 256×256×256. In such an embodiment, a large memory capacitance of 256×256×256 may be used, such that the number of the reference data stored in the 3D LUTs 310 may be less than a total gradation number of the primary image data DATA1.

When the total gradation number of the primary image data DATA1 is L, the number of the reference data stored in the 3D LUTs 310 may be M less than L. Here, ‘L’ and ‘M’ are natural numbers. The reference data of each of the 3D LUTs 310 may be stored in a same interval or different intervals.

The reference data in each of the 3D LUTs 310 may be stored in N-gradation interval, where ‘N’ is a divisor of a total gradation number of the primary image data DATA1, e.g., ‘L’. In one exemplary embodiment, for example, when a total gradation of the primary image data DATA1 is 256, N may be 32 or 64.

In one exemplary embodiment, for example, when N is 32, the reference data stored in each of the 3D LUTs 310 are stored in 32-gradation interval. In such an embodiment, each of the 3D LUTs 310 may have a capacity of 9×9×9. In an alternative exemplary embodiment, when N is 64, the reference data in each of the 3D LUTs 310 are stored in 64-gradation interval. More particularly, the reference data stored in each of the 3D LUTs 310 may have 0-gradation, 63-gradation, 127-gradation, 191-gradation and 255-gradation. In such an embodiment, each of the 3D LUTs 310 may have a capacity of 5×5×5.

As shown in FIG. 3, the red LUT includes red color correction data mapped in correspondence with the red, green and blue data. As shown in FIG. 3, the red green and blue data of the reference data in the red LUT are stored in a same interval of 64-gradation, and the red LUT has a capacity of 5×5×5.

In one exemplary embodiment, For example, red data of the reference data are arranged in a first direction ‘x’ and have 0-gradation, 63-gradation, 127-gradation, 191-gradation and 255-gradation. Green data of the reference data are arranged in a second direction ‘y’ substantially perpendicular to the first direction ‘x’ and have 0-gradation, 63-gradation, 127-gradation, 191-gradation and 255-gradation. Similarly, blue data of the reference data are arranged in a third direction ‘y’ substantially perpendicular to the second direction ‘y’ and have 0-gradation, 63-gradation, 127-gradation, 191-gradation and 255-gradation.

In FIG. 3, an exemplary embodiment of the red LUT is shown for convenience of description. In an exemplary embodiment, the green LUT and the blue LUT may be substantially similar to the red LUT. As shown in FIG. 3, the LUT may be set as a capacity of 5×5×5, but not being limited thereto. In an alternative exemplary embodiment, the LUT may be set as various capacities such as 7×7×7 or 9×9×9.

FIG. 4 shows a gamma curve of the reference data and the stored color correction data DATA_LUT in the LUT of FIG. 3. In an exemplary embodiment, as described above, the reference data may be stored in a same interval of 64-gradation. In such an embodiment, a variation of the stored color correction data with respect to the reference data at a high gradation area A and a low gradation area B may be greater than the variation of the stored color correction data with respect to the reference data at a middle gradation area.

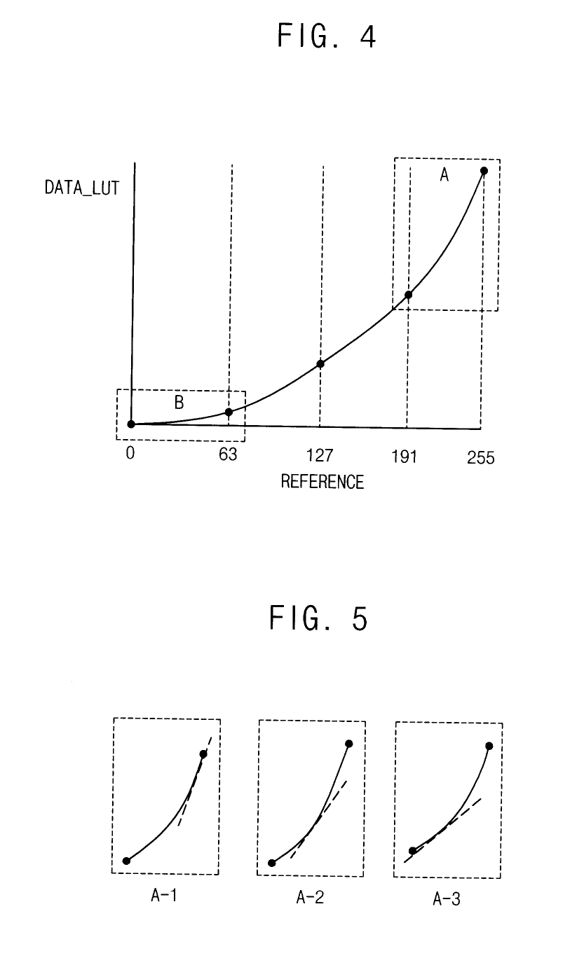

FIG. 5 shows a first area A-1, a second area A-2 and a third area A-3 of the high gradation area A. As shown in FIG. 5, slopes of the first area A-1, the second area A-2 and the third area A-3 are substantially varied. Although not shown in FIG. 5, slopes of the low gradation area B may be substantially varied.

Thus, when the 3D interpolating part 330 interpolates the stored color correction data DATA_LUT in the 3D LUTs 310, errors of the stored color correction data DATA_LUT at the high gradation area A and the low gradation area B may be greater than errors of the stored color correction data DATA_LUT at the middle gradation area.

In an exemplary embodiment, reference data intervals at a high gradation area A and at a low gradation area B may be set to be less than reference data intervals at the middle gradation area to reduce the error of the color correction data DATA.

As shown in FIG. 6, a capacity of 5×5×5 of each of the 3D LUTs 310 may be maintained, while the reference data intervals at the middle gradation area may be increased, and the reference data intervals at the high gradation area A and at the low gradation area B may be decreased to be less than the reference data intervals at the middle gradation area. Thus, reference data intervals of each of the 3D LUTs 310 may be different from each other.

In an exemplary embodiment, the reference data intervals at the high gradation area A and at the low gradation area B may be substantially equal to each other, and values of the reference data may be symmetric to each other with respect to a center gradation value. In an alternative exemplary embodiment, the reference data intervals at the high gradation area A and at the low gradation area B may be substantially different from each other, and values of the reference data may be asymmetric to each other with respect to the center gradation value.

The high gradation area A may be an area corresponding to about 5% to about 30% of total gradation numbers of the maximum gradation value. In one exemplary embodiment, for example, the high gradation area A may be an area corresponding to about 12.5% to about 25% of the total gradation numbers of the maximum gradation value. The low gradation area B may be an area corresponding to about 5% to about 30% of total gradation numbers of a minimum gradation value. In one exemplary embodiment, for example, the low gradation area B may be an area corresponding to about 12.5% to about 25% of the total gradation numbers of the minimum gradation value. In an alternative exemplary embodiment, the high gradation area A and the low gradation area B may be set differently from the high gradation area A and the low gradation area B described above based on a linearity of variation of the stored color correction data with respect to the reference data.

In an exemplary embodiment, as shown in FIG. 6, a reference data interval at the high gradation area A and the low gradation area B is 32-gradation, and a reference data interval at the middle gradation area is 96-gradation. However, the reference data interval may be variously set based on a bit number of the primary image data DATA1 and a size of the LUT.

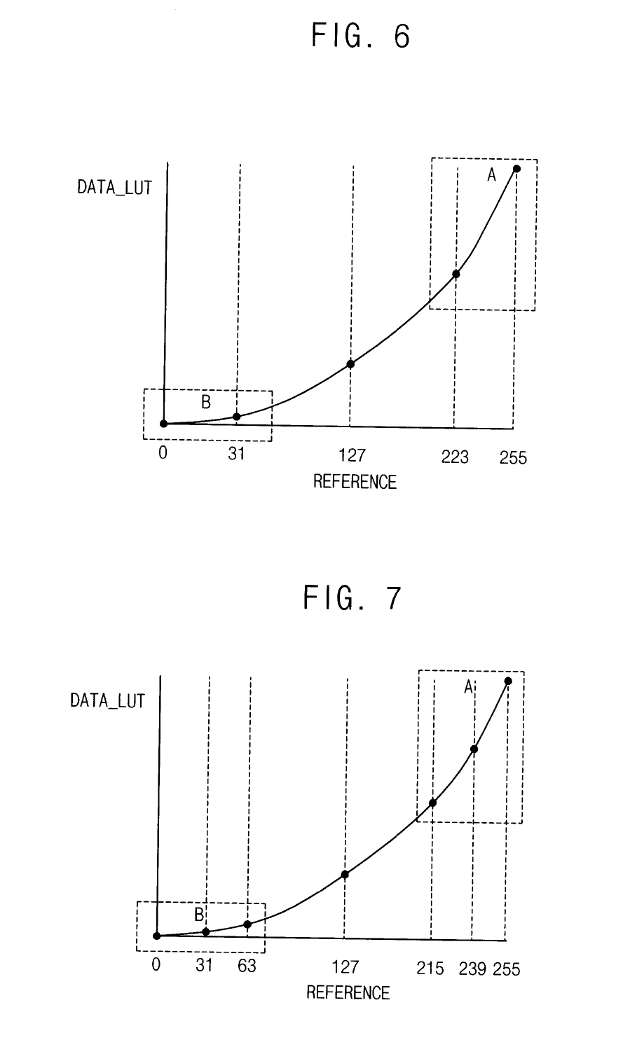

In an alternative exemplary embodiment, as shown in FIG. 7, a capacity of each of the 3D LUTs 310 may be 7×7×7, the reference data intervals at the middle gradation area may be increased, and the reference data intervals at the high gradation area A and at the low gradation area B may be decreased to be less than the reference data intervals at the middle gradation area.

In an exemplary embodiment, the reference data intervals at the high gradation area A and at the low gradation area B may be substantially equal to each other, and values of the reference data may be symmetric to each other with respect to the center gradation value. In an alternative exemplary embodiment, the reference data intervals at the high gradation area A and at the low gradation area B may be substantially different from each other, and values of the reference data may be asymmetric to each other with respect to the center gradation value.

In an exemplary embodiment, as shown in FIG. 7, the reference data interval at the high gradation area A may be 16-gradation, and the reference data interval at the low gradation area B may be 32-gradation. However, the reference data interval may be variously set in accordance with a bit number of the primary image data DATA1 and a size of the LUT.

When at least one of the red, green and blue data of the primary image data DATA1 is identical to the reference data stored in the 3D LUTs 330, the 3D interpolating part 330 interpolates the stored color correction data DATA_LUT in the 3D LUTs 330 to output the color correction data DATA.

In an exemplary embodiment, the 3D interpolating part 330 may use a tri-linear interpolation method or quadratic spline interpolation method. Hereinafter, a tri-linear interpolation method of the 3D interpolating part 330 will be described in detail.

FIG. 8 is a conceptual diagram showing an exemplary embodiment of the interpolation method used in the 3D interpolating part of FIG. 2.

Referring to FIG. 8, color correction data not stored in the 3D LUTs 310 but to be computed in the 3D interpolating part 330 are referred to as “Gn.” The Gn may be computed using the stored color correction data DATA_LUT in the 3D LUTs 310.

In one exemplary embodiment, for example, when one or two of the red, green and blue data of the primary image data DATA1 are identical to the reference data in the 3D LUTs 310, the Gn may be interpolated using four stored color correction data DATA_LUT near to the Gn. When all of the red, green and blue data of the primary image data DATA1 are not identical to the reference data in the 3D LUTs 310, the Gn may be interpolated using eight stored color correction data DATA_LUT near to Gn.

In such an embodiment, the primary image data DATA1 may further include two bits data which designate an address at the 3D LUTs 310. The 3D interpolating part 330 may detect the stored color correction data DATA_LUT near to Gn using the two bits data which designate the address.

In FIG. 8, all of the red, green and blue data of the primary image data DATA1 corresponding to the Gn are not identical to the reference data stored in the 3D LUTs 310. Thus, the Gn is computed using values of <f000>, <f010>, <f110>, <f100>, <f001>, <f011>, <f111> and <f101> near to the Gn. The values of <f000>, <f010>, <f110>, <f100>, <f001>, <f011>, <f111> and <f101> are the stored color correction data in the 3D LUTs 310.

The values of <f000>, <f010>, <f110> and <f100> are on a first planar surface, and the values of <f001>, <f011>, <f111> and <f101> are on a second planar surface parallel to the first planar surface. When a position corresponding to the Gn at the first planar surface is XY0 and a position corresponding to the Gn at the second planar surface is XY1, each position of XY0 and XY1 may be defined as the following Equations 1 and 2, respectively.

XY₀=f₀₀₀+a₀x+b₀y+c₀xy [Equation 1]

XY₁=f₀₀₁+a₁x+b₁y+c₁xy [Equation 2]

Coefficients of Equation 1 and Equation 2 may be defined as the following Equations 3 to 8.

a₀=f₁₀₀−f₀₀₀ [Equation 3]

b₀=f₀₁₀−f₀₀₀ [Equation 4]

c₀=f₀₀₀+f₁₁₀−f₀₁₀−f₁₀₀ [Equation 5]

a₁=f₁₀₁−f₀₀₁ [Equation 6]

b₁=f₀₁₁−f₀₀₁ [Equation 7]

c₁=f₀₀₁+f₁₁₁−f₀₁₁−f₁₀₁ [Equation 8]

A position relationship of Gn, XY0 and XY1 may be defined as the following Equation 9.

1:z=XY₁−XY₀:Gₙ−(f₀₀₀+a₀x+b₀y+c₀xy) [Equation 9]

When Equation 9 is rearranged for Gn, it may be defined as the following Equation 10.

Gₙ=f₀₀₀+a₀x+b₀y+(f₀₀₁−f₀₀₀)z+c₀xy+(b₁−b₀) yz+(a₁−a₀)xz+(c₁−c₀)xyz [Equation 10]

When coefficients of Equation 10 are rearranged, Gn may be defined as the following Equation 11.

Gₙ=f₀₀₀+ax+by+cz+dxy+eyz+fxz+gxyz [Equation 11]

Coefficients of linear interpolation of Equation 11 may be defined as the following Equations 12 to 18.

a=f₁₀₀−f₀₀₀ [Equation 12]

b=f₀₁₀−f₀₀₀ [Equation 13]

c=f₀₀₁−f₀₀₀ [Equation 14]

d=f₀₀₀+f₁₁₀−f₀₁₀−f₁₀₀ [Equation 15]

e=f₀₀₀+f₀₁₁−f₀₁₀−f₀₀₁ [Equation 16]

f=f₀₀₀+f₁₀₁−f₀₀₁−f₁₀₀ [Equation 17]

g=f₀₀₁+f₀₁₀+f₁₀₀+f₁₁₁−f₀₀₀−f₀₀₁−f₁₀₁−f₁₁₀ [Equation 18]

In Equations 12 to 18, ‘a’, ‘b’, ‘c’, ‘d’, ‘e’, ‘f’ and ‘g’ that are coefficients of a linear-interpolation may be pre-computed for fast computation and to be pre-stored in the 3D LUTs 310.

Referring back to FIG. 2, the 1D color correcting part 500 generates the color correction data DATA of the primary image data DATA1 in response to the planar image mode signal 2D-mode. The 1D color correcting part 500 includes a plurality of 1D LUTs 510 and a 1D interpolating part 530.

The 1D LUTs 510 have stored color correction data mapped with reference data in one-to-one correspondence. In an exemplary embodiment, the stored color correction data one-to-one corresponds to red data, green data and blue data of primary image data DATA1 in the 1D LUTs 510.

A gradation range of the stored color correction data in the 1D LUTs 510 may be less than a gradation range of the primary image data DATA1, similarly to the stored color correction data DATA_LUT of the 3D LUTs 310. In one exemplary embodiment, for example, a minimum gradation value of the stored color correction data in the 1D LUTs 501 may be substantially equal to a minimum gradation value of the primary image data DATA1, and a maximum gradation value of the stored color correction data in the 1D LUTs 501 may be less than a maximum gradation value of the primary image data DATA1. The maximum gradation value of the stored color correction data in the 1D LUTs 501 may be a value corresponding to a maximum gradation value of compensated data DATA2 perceived in a unit frame interval.

In an alternative exemplary embodiment, LUTs which are used in a conventional adaptive color correcting (“ACC”) technology may be used as the 1D LUTs 510.

In such an embodiment, the 1D LUTs 510 may store red color correction data, green color correction data and blue color correction data. In one exemplary embodiment, for example, the 1D LUTs 510 may include the red color correction data mapped with the red data, the green color correction data mapped with the green data, and the blue color correction data mapped with the blue data.

In an exemplary embodiment, the number of reference data stored in the 1D LUTs 310 may be set to be less than total gradation numbers of the primary image data DATA1 to decrease a capacity of the 1D LUTs 510.

When each of the red, green and blue data of the primary image data DATA1 is identical to the red, green and blue data of the reference data stored in the 1D LUTs 510, the 1D interpolating part 530 interpolates the stored color correction data in the 1D LUTs 510 to output the color correction data DATA of the primary image data.

The over-driving part 700 converts the color correction data DATA to the compensated data DATA2. The compensated data DATA2 is a value which overdrives the color correction data DATA of a current frame by comparing color correction data of a previous frame with the color correction data DATA of the current frame to enhance liquid crystal response speed.

In an exemplary embodiment, the primary image data DATA1 may be 8 bits data, e.g., data having a gradation range of 0-gradation to 255-gradation, and the display apparatus may use a driving frequency of about 120 (hertz) Hz.

In one exemplary embodiment, for example, when the color correction data of the previous frame is 0-gradation and the color correction data DATA of the current frame is 240-gradation, the compensated data DATA2 of the color correction data DATA of the current frame may be about 255-gradation. When the compensated data DATA2 is 255-gradation, 240-gradation may be perceived in a unit frame interval (e.g., 1/120 sec) due to liquid crystal response speed.

In such an embodiment, a maximum gradation value of the stored color correction data may be 240-gradation, and thus the stored color correction data may have a gradation range of 0-gradation to 240-gradation. The compensated data DATA2 may have a gradation range of 0-gradation to 255-gradation, which is substantially identical to the gradation range of the primary image data DATA1.

The over-driving part 700 may use an LUT, in which a plurality of compensated data DATA2 of a current frame are mapped in correspondence with the color correction data DATA of a previous frame and the color correction data DATA of the current frame.

In an exemplary embodiment, when the primary image data DATA1 is stereoscopic image data, the 3D color correcting part 310 generates the color correction data DATA having a gradation range less than a gradation range of the primary image data DATA1 using the 3D LUTs 310. In an exemplary embodiment, the over-driving part 700 generates the compensated data DATA2 having a gradation range substantially identical to the gradation range of the primary image data DATA1.

Thus, a maximum gradation value of the color correction data DATA corresponds to a maximum gradation value of the compensation data DATA2 perceived in a unit frame, such that crosstalk of the stereoscopic image due to response delay of liquid crystals is substantially reduced, and the primary image data DATA1 is compensated using the 3D LUTs 310, such that color reproducibility of a display apparatus is substantially enhanced.

FIG. 9 is a block diagram showing an alternative exemplary embodiment of the data compensating part according to the present invention.

The data compensating part 151 in FIG. 9 is substantially the same as the data compensating part 150 shown in FIG. 2 except at least for a dithering part 600. The same or like elements shown in FIG. 9 have been labeled with same reference characters as used above to describe the exemplary embodiment of the data compensating part in FIG. 2, and any repetitive detailed description thereof will hereinafter be omitted or simplified.

Referring to FIG. 9, the data compensating part 151 includes a 3D color correcting part 301, a 1D color correcting part 600 and an over-driving part 701.

The 3D color correcting part 301 generates the color correction data DATA of the primary image data DATA1 in response to the stereoscopic image mode signal 3D-mode, and generates the color correction data DATA of the primary image data DATA1 in response to the planar image mode signal 2D-mode.

The dithering part 600 temporally and/or spatially dithers the color correction data DATA outputted from the 3D color correcting part 301 and the 1D color correcting part 501, and then outputs the dithered color correction data DATA′ to the over-driving part 701.

When the number of bits to be processed at the data driver 171 is less than the number of bits of the color correction data DATA outputted from the 3D color correcting part 301 and the 1D color correcting part 501, the dithering part 600 outputs a dithered color correction data DATA′ by reconfiguring the compensation data DATA.

In one exemplary embodiment, for example, the number of bits of the color correction data DATA outputted from the 3D color correcting part 301 and the 1D color correcting part 501 is 10 bits and the number of bits to be processed at the data driver 171 is 8 bits, the color correction data DATA is reconfigured to realize the color correction data DATA of the 10 bits into 8 bits.

In an exemplary embodiment, the dithering part 600 dithers the color correction data DATA outputted from both the 3D color correcting part 301 and the 1D color correcting part 501. In an alternative exemplary embodiment, the dithering part 600 may dither only the color correction data DATA outputted from the 3D color correcting part 301.

In an exemplary embodiment, the color correction data DATA is dithered, such that a luminance decrease due to the color correction data DATA having a range less than a gradation range of the primary image data DATA1 may be compensated.

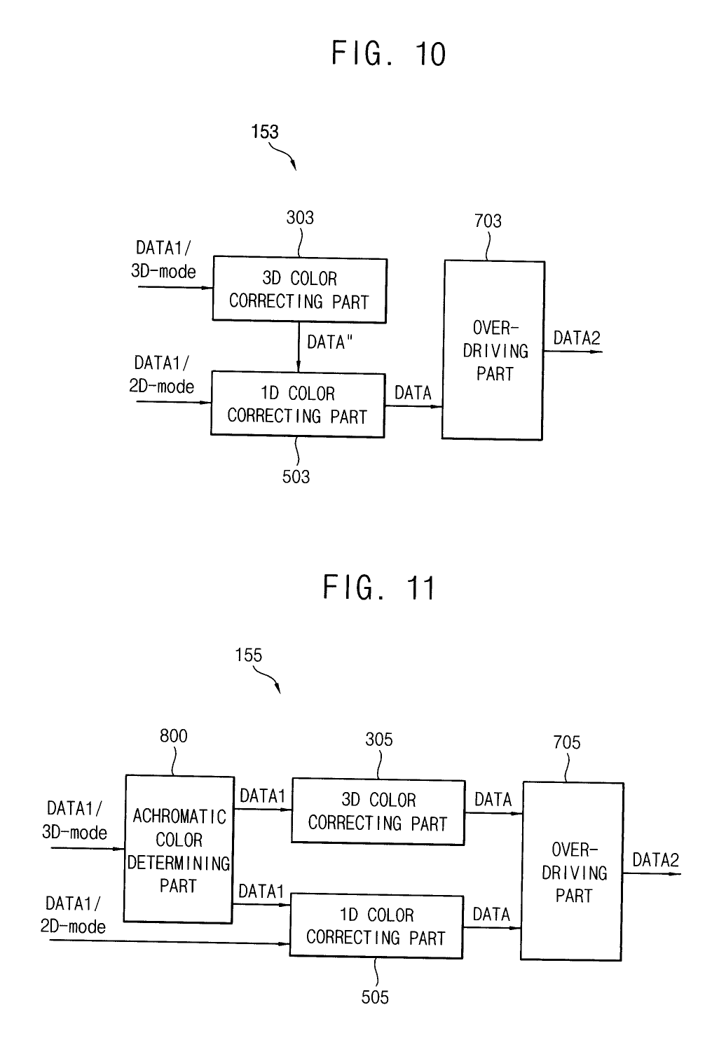

FIG. 10 is a block diagram showing another alternative exemplary embodiment of the data compensating part according to the present invention.

The data compensating part 153 in FIG. 10 is substantially the same as the data compensating part 150 shown in FIG. 2 except at least for a 3D color correcting part 303. The same or like elements shown in FIG. 10 have been labeled with the same reference characters as used above to describe the exemplary embodiment shown in FIG. 2, and any repetitive detailed description thereof will hereinafter be omitted or simplified.

Referring to FIG. 10, the data compensating part 153 includes a 3D color correcting part 303, a 1D color correcting part 503 and an over-driving part 703. Although not shown in FIG. 10, the compensation part 153 may further include the dithering part 600 shown in FIG. 9.

The 3D color correcting part 303 generates a color correction data DATA″ of the primary image data DATA1 in response to the stereoscopic image mode signal 3D-mode, and outputs the color correction data DATA″ of the primary image data DATA1 to the 1D color correcting part 503.

The 1D color correcting part 503 generates a color correction data DATA of the primary image data DATA1 in response to the planar image mode signal 2D-mode. The 1D color correcting part 503 performs an additional color correction for the color correction data DATA″ outputted from the 3D color correcting part 303.

Thus, when the primary image data DATA1 is stereoscopic image data, the color correction data DATA″ generated at the 3D color correcting part 303 is additionally compensated at the 1D color correcting part 503 to be outputted to the over-driving part 703.

In an exemplary embodiment, color correction is operated substantially accurately, such that color reproducibility of a display apparatus is substantially enhanced.

FIG. 11 is a block diagram showing an alternative exemplary embodiment of the data compensating part according to the present invention.

The data compensating part 155 in FIG. 11 is substantially the same as the data compensating part 150 shown in FIG. 2 except at least for an achromatic color determining part 800. The same or like elements shown in FIG. 2 have been labeled with the reference characters as used above to describe the exemplary embodiment of the data compensating part shown in FIG. 2, and any repetitive detailed description thereof will hereinafter be omitted or simplified.

Referring to FIG. 11, the data compensating part 155 includes an achromatic color determining part 800, a 3D color correcting part 305, a 1D color correcting part 505 and an over-driving part 705. Although not shown in FIG. 11, the data compensating part 153 may further include the dithering part 600 shown in FIG. 9.

The achromatic color determining part 800 determines whether or not the primary image data DATA1 corresponds to an achromatic color image. When it is determined that the primary image data DATA1 corresponds to an achromatic color image, the achromatic color determining part 800 outputs the primary image data DATA1 to the 1D color correcting part 505.

In one exemplary embodiment, for example, the achromatic color determining part 800 receives the stereoscopic image mode signal 3D-mode and the primary image data DATA1 provided from the stereoscopic image determining part 140 to determine whether or not red, green and blue data of the primary image data DATA1 are substantially identical to each other.

When the red, green and blue data of the primary image data DATA1 are substantially identical to each other, the primary image data DATA1 corresponds to an achromatic color. When the red, green and blue data of the primary image data DATA1 are not identical to each other, the primary image data DATA1 corresponding to a chromatic color image.

When the primary image data DATA1 corresponds to a chromatic color image, the achromatic color determining part 800 outputs the primary image data DATA1 to the 3D color correcting part 305. When the primary image data DATA1 corresponds to an achromatic color image, the achromatic color determining part 800 outputs the primary image data DATA1 to the 1D color correcting part 505.

A color difference between an achromatic color and a chromatic color having a gradation value substantially identical to the achromatic color is substantially great. When the primary image data DATA1 corresponds to an achromatic color image and a color is compensated by the 3D color correcting part 305, the color coordinate corresponding to the compensated color is distorted such that the compensated color may be perceived as a different color. Thus, even when the primary image data DATA1 is stereoscopic image data, color correction may be performed by the 1D color correcting part 505 when the primary image data DATA1 corresponds to an achromatic color image.

In an exemplary embodiment, an operation of color correction is performed by the 3D color correcting part 305 when the stereoscopic image data corresponds to a chromatic color image, an operation of color correction is performed by the 1D color correcting part 505 when the stereoscopic image data corresponds to an achromatic color image, and display quality of a display apparatus is thereby substantially improved.

As described above, according to exemplary embodiments, when a primary image data is stereoscopic image data, a 3D color correcting part generates the color correction data having a gradation range less than a gradation range of the primary image data using the 3D LUTs, and generates compensated data of a gradation range substantially identical to a gradation range of the primary image data. Thus, crosstalk of a stereoscopic image due to response delay of liquid crystals may be effectively prevented.

In exemplary embodiments, a stereoscopic image is compensated using the 3D LUTs, such that color reproducibility of a display apparatus is substantially enhanced. Furthermore, a plurality of 1D LUTs is used when the stereoscopic image is an achromatic color image, such that display quality of a display apparatus is substantially improved.

The foregoing is illustrative of the present invention and is not to be construed as limiting thereof Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of compensating data, the method comprising:
generating color correction data of primary image data using a plurality of three-dimensional look-up tables in response to the primary image data and a stereoscopic image mode signal, wherein stored color correction data in the three-dimensional look-up tables are mapped with reference data in the three-dimensional look-up tables in one-to-three correspondence, and a gradation range of the stored color correction data in the three-dimensional look-up tables is less than a gradation range of the primary image data; and
converting the generated color correction data to compensated data based on the generated color correction data of the primary image data and the color correction data of the primary image data of a previous frame, wherein a gradation range of the compensated data is substantially identical to the gradation range of the primary image data.

2. The method of claim 1, wherein
a minimum gradation value of the stored color correction data in the three-dimensional look-up tables is substantially equal to a minimum gradation value of the primary image data,
a maximum gradation value of the stored color correction data in the three-dimensional look-up tables is less than a maximum gradation value of the primary image data, and
the maximum gradation value of the stored color correction data in the three-dimensional look-up tables corresponds to a maximum gradation value of the compensated data perceived in a unit frame.

3. The method of claim 1, wherein the generating color correction data of primary image data comprises:
outputting the stored color correction data in the three-dimensional look-up tables from the three-dimensional look-up tables; and
interpolating the outputted stored color correction data in the three-dimensional look-up tables to compute the color correction data of the primary data.

4. The method of claim 1, wherein the generating color correction data of primary image data comprises:
determining whether or not red data of the primary image data, green data of the primary image data and blue data of the primary image data are substantially identical to each other;
outputting the color correction data of the primary image data using a plurality of one-dimensional look-up tables when the red, green and blue data of the primary image data are substantially identical to each other; and
outputting the color correction data of the primary image data using the one-dimensional look-up tables and the three-dimensional look-up tables when the red, green and blue data of the primary image data are different from each other.

5. The method of claim 1, wherein the generating color correction data of a primary image data comprises:
temporally or spatially dithering the color correction data of the primary image data.

6. A data compensation apparatus comprising:
a three-dimensional color correcting part configured to generate color correction data of primary image data using a plurality of three-dimensional look-up tables in response to the primary image data and a stereoscopic image mode signal, wherein stored color correction data in the three-dimensional look-up tables are mapped with reference data in the three-dimensional look-up tables in one-to-three correspondence, and a gradation range of the stored color correction data in the three-dimensional look-up tables is less than a gradation range of the primary image data; and
an over-driving part configured to convert the generated color correction data to a compensated data based on the generated color correction data of the primary image data and the color correction data of the primary image data of a previous frame, wherein a gradation range of the compensated data is substantially identical to a gradation range of the primary image data.

7. The data compensation apparatus of claim 6, wherein
a minimum gradation value of the stored color correction data in the three-dimensional look-up tables is substantially equal to a minimum gradation value of the primary image data,
a maximum gradation value of the stored color correction data in the three-dimensional look-up tables is less than a maximum gradation value of the primary image data, and
the maximum gradation value of the stored color correction data in the three-dimensional look-up tables corresponds to a maximum gradation value of the compensated data perceived in a unit frame.

8. The data compensation apparatus of claim 6, wherein the three-dimensional color correcting part comprises:
a three-dimensional interpolating part configured to interpolate the stored color correction data in the three-dimensional look-up tables to compute the color correction data of the primary image data.

9. The data compensation apparatus of claim 8, wherein
a total gradation number of the primary image data is L, which is a natural number, and
the number of the reference data in each of the three-dimensional look-up tables is M, which is a natural number less than L.

10. The data compensation apparatus of claim 9, wherein the reference data in each of the three-dimensional look-up tables are stored in N-gradation interval, wherein N is a divisor of L.

11. The data compensation apparatus of claim 9, wherein the reference data in each of the three-dimensional look-up tables is stored in P-gradation interval on a middle gradation area, and is stored in Q-gradation interval on each of a low gradation area and a high gradation area, wherein P is a natural number, and Q is a natural number less than P.

12. The data compensation apparatus of claim 9, wherein the reference data in each of the three-dimensional look-up tables is stored in P-gradation interval on a middle gradation area, is stored in Q-gradation interval on a low gradation area, and is stored in R-gradation interval on a high gradation area, wherein P is a natural number, Q is a natural number less than P, and R is a natural number less than P and different from Q.

13. The data compensation apparatus of claim 6, wherein each of the three-dimensional look-up tables comprises:
a red look-up table, in which red color correction data in correspondence with red, green and blue data of the primary image data are mapped;
a green look-up table, in which green color correction data in correspondence with the red, green and blue data of the primary image data are mapped; and
a blue look-up table, in which blue color correction data in correspondence with the red, green and blue data of the primary image data are mapped.

14. The data compensation apparatus of claim 6, further comprising a one-dimensional color correcting part,
wherein the one-dimensional color correcting part comprises:
a one-dimensional look-up table, in which stored color correction data therein are mapped with reference data therein in one-to-one correspondence; and
a one-dimensional color interpolating part configured to interpolate the stored color correction data in the one-dimensional look-up tables to compute the color correction data of the primary image data.

15. The data compensation apparatus of claim 14, wherein the three-dimensional color correcting part outputs the color correction data of the primary image data to the one-dimensional color correcting part.

16. The data compensation apparatus of claim 6, further comprising:
an achromatic color determining part configured to determine whether or not red data of the primary image data, green data of the primary image data and blue data of the primary image data are substantially identical to each other, to output the primary image data to the one-dimensional color correcting part when the red, green and blue data of the primary image data are substantially identical to each other, and to output the primary image data to the three-dimensional color correcting part when the red, green and blue data of the primary image data are different from each other.

17. The data compensation apparatus of claim 6, further comprising:
a dithering part configured to temporally or spatially dither the color correction data of the primary image data.

18. A display apparatus comprising:
a stereoscopic image determining part configured to determine whether or not primary image data provided from an external device are stereoscopic image data to output the primary image data when the primary image data are the stereoscopic image data;
a data compensating part comprising:
a three-dimensional color correcting part configured to generate color correction data of primary image data using a plurality of three-dimensional look-up tables in response to the primary image data and a stereoscopic image mode signal, wherein stored color correction in the three-dimensional look-up tables data is mapped with reference data in the three-dimensional look-up tables, and a gradation range of the stored color correction data in the three-dimensional look-up tables is less than a gradation range of the primary image data; and
an over-driving part configured to convert the generated color correction data of the primary image data to a compensated data based on the generated color correction data of the primary image data and the color correction data of the primary image data of a previous frame, wherein a gradation range of the compensated data is substantially identical to a gradation range of the primary image data;
a display panel which displays an image;
a panel driving part configured to provide the display panel with the compensated data;
a light source part disposed below the display panel and configured to provide the display panel with lights; and
a light source driver configured to drive the light source part.

19. The display apparatus of claim 18, wherein the light source driver increases a luminance of the light source part in response to the stereoscopic image mode signal.

20. The display apparatus of claim 18, wherein the stereoscopic image determining part outputs the stereoscopic image mode signal based on at least one of a toggle signal provided from the external device and a stereoscopic image enable signal provided from the external device.
